(19) United States
(12) Patent Application Publication
(10) Pub. No.: US 2012/0125751 A1
(43) Pub. Date: May 24, 2012

(54) MULTI DIRECTION SWITCH

(75) Inventors: Yusho Nakase, Yokohama (JP); Wei-Ping Liu, Shenzhen (CN); Liang Sun, Shenzhen (CN); Yi-Guo Qi, Shenzhen (CN)

(73) Assignee: HON HAI PRECISION INDUSTRY CO., LTD., New Taipei (TW)

(21) Appl. No.: 13/303,641

(22) Filed: Nov. 23, 2011

(30) Foreign Application Priority Data
Nov. 23, 2010 (CN) 201010555112.5

(51) Int. Cl. H01H 13/64

(52) U.S. Cl. 200/345

(57) ABSTRACT

A multi direction switch (100) includes an upper housing (3), a lower housing (6), a bottom cover (11), an elastic ring (5), an actuator (4), an operating button (1), a terminal plate (7), a moveable electrode plate (8), an insulative layer (10), and a fixed electrode plate (9). The upper housing and the lower housing define a channel (361) and a first receiving space (362) for receiving the elastic ring. The bottom cover is attached to the lower housing for defining a second receiving space (611) therebetween. The actuator has a bracket (41) connecting with the elastic ring via the channel and an actuating portion (42) extending from the bracket towards the bottom cover. The terminal plate, the moveable electrode plate, the insulative layer, and the fixed electrode plate are positioned along an upper-and-lower direction and received in the second receiving space.

### BACKGROUND OF THE INVENTION

1. Field of the Invention

The present invention relates generally to a multi direction switch, and more particularly to a multi direction switch capable of altering opposing area of two electrode plates to output different signals denoting desired input operations or positions.

2. Description of Related Arts

A multi direction switch is widely used in an electronic appliance for denoting multi positions when the electronic appliance is in use. The known multi direction switch comprises two fixed electrode plates and an insulative layer located between the fixed electrode plates. The fixed electrode plates have capacitance therebetween. The insulative layer is moveable along the fixed electrode plates and alters opposing area of the fixed electrode plates. Therefore, the capacitance is altered. The fixed electrode plates are soldered with a printed circuit board and then different signals are output because of different capacitance between the fixed electrode plates, denoting various positions of the electronic appliance. The multi direction switch further comprises an operating button to move the insulative layer.

U.S. Pat. No. 7,310,083 B2 issued to Hagiwara et al. on Dec. 18, 2007 discloses a conventional multi direction switch. As shown in FIGS. 13 and 14 of this patent, the conventional multi direction switch includes top and bottom covers jointly defining a receiving space, a plurality of contacts, a fixed electrode, a movable electrode opposite to the fixed electrode, an elastic member peripherally enclosing the movable electrode, and a knob for horizontally driving the movable electrode. The movable electrode is in an initial position before a sliding operation is provided. When the movable electrode slides in a certain direction, the elastic member is stretched in that certain direction and a capacitance between the fixed electrode and the movable electrode is variable due to the changing opposing areas therebetween. When the sliding operation of the movable electrode is finished, a resilient force of the elastic member stretched in that certain direction forces the movable electrode to return automatically to the initial position. However, with the contacts, the fixed electrode, the movable electrode, the elastic member, and a major part of the knob all received in a limited, single receiving space, the movable electrode is easily influenced by other components.

Hence, a new multi direction switch facilitating alteration of opposing area of two electrode plates is desired to overcome the aforementioned disadvantage of the prior art.

### SUMMARY OF THE INVENTION

Accordingly, an object of the present invention is to provide a new multi direction switch facilitating alteration of opposing area of two electrode plates.

To achieve the above object, a multi direction switch includes an upper housing, a lower housing, a bottom cover, an elastic ring, an actuator, an operating button, a terminal plate, a moveable electrode plate, an insulative layer, and a fixed electrode plate. The upper housing and the lower housing define a channel and a first receiving space communicating with outside via the channel. The bottom cover is attached to the lower housing for defining a second receiving space therebetween. The elastic ring is received in the first receiving space. The actuator has a bracket connecting with the elastic ring via the channel and an actuating portion extending from the bracket towards the bottom cover. The operating button has an operating portion positioned upon the upper housing and a protrusion extending downwardly from the operating portion. The protrusion is retained by the bracket. The terminal plate, the moveable electrode plate, the insulative layer, and the fixed electrode plate are positioned along an upper-and-lower direction and received in the second receiving space. The moveable electrode plate is overlapped on the actuating portion of the actuator.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a multi direction switch constructed in accordance with the present invention;

FIG. 2 is a perspective, exploded view of the multi direction switch;

FIG. 3 is another view of FIG. 2; and

FIG. 4 is cross-sectional view taken along line 4-4 of FIG. 1.

### DETAILED DESCRIPTION OF THE PREFERRED EMBODIMENT

Reference will now be made in detail to the preferred embodiment of the present invention.

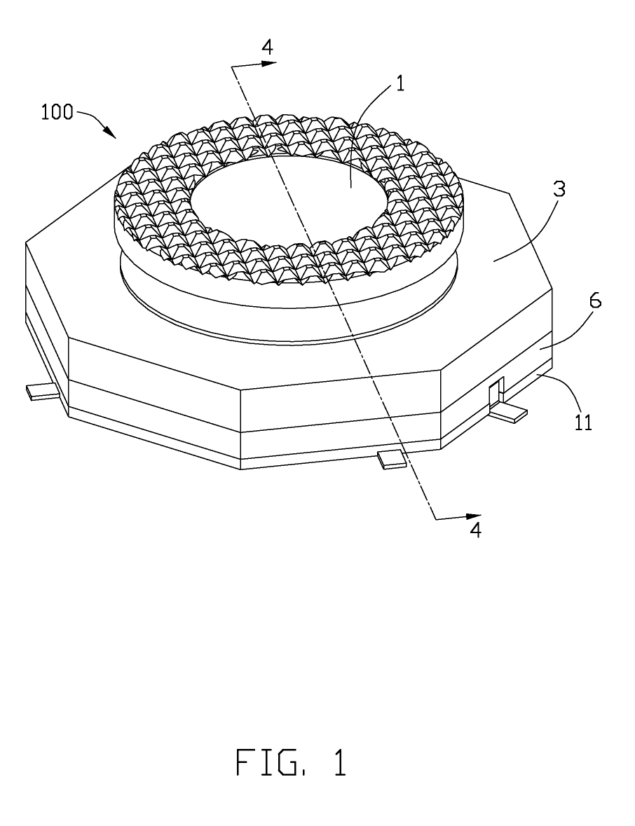

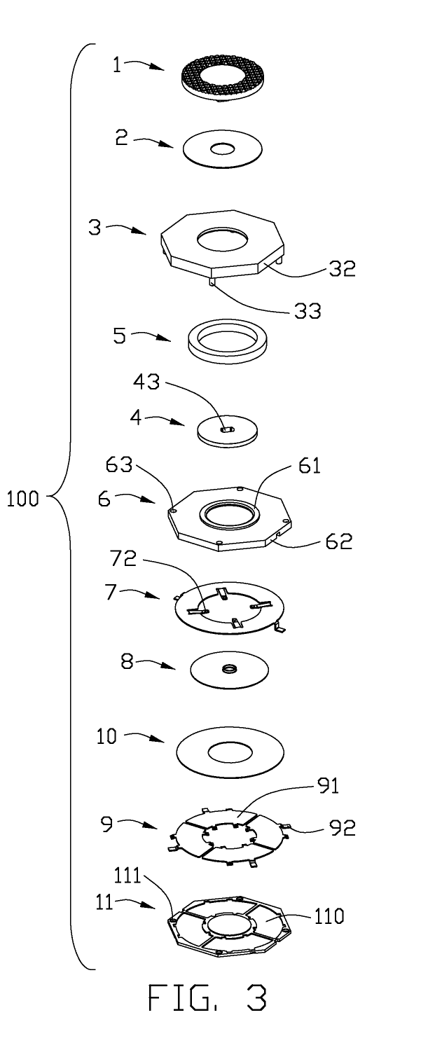

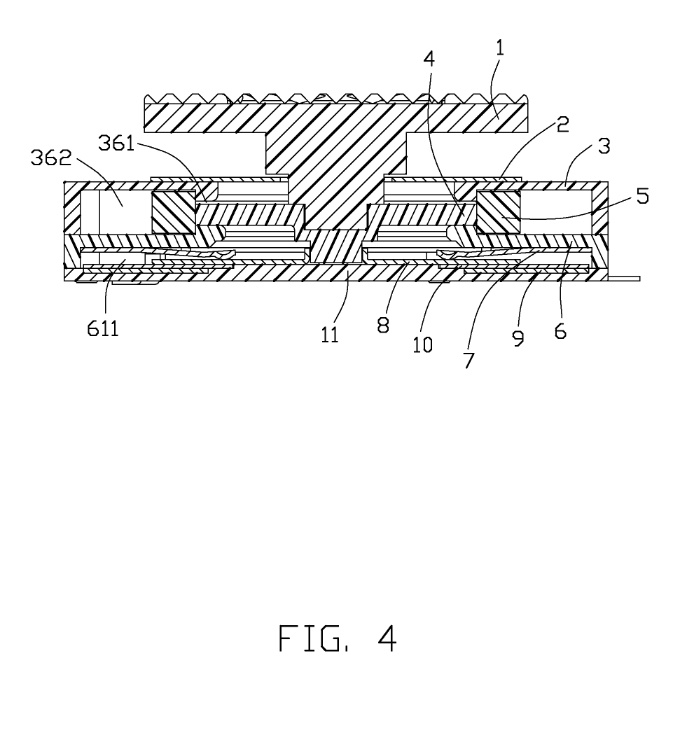

Referring to FIGS. 1-4, a multi direction switch 100 used for denoting multi positions of an electronic appliance (not shown), at which the multi direction switch 100 is assembled in accordance with the present invention, comprises an operating button 1, a dust-preventing plate 2, an upper housing 3, an actuator 4, an elastic ring 5, a lower housing 6, a terminal plate 7, a moveable electrode plate 8, a fixed electrode plate 9, an insulative layer 10, and a bottom cover 11, all of which together define a same axis. The terminal plate 7 and the fixed electrode plate 9 of the multi direction switch 100 are soldered on a printed circuit board (not shown) of the electronic appliance for electrical connection. The moveable electrode plate 8 and the fixed electrode plate 9 have altered capacitance and therefore, different signals are output for denoting multi positions of the electronic appliance.

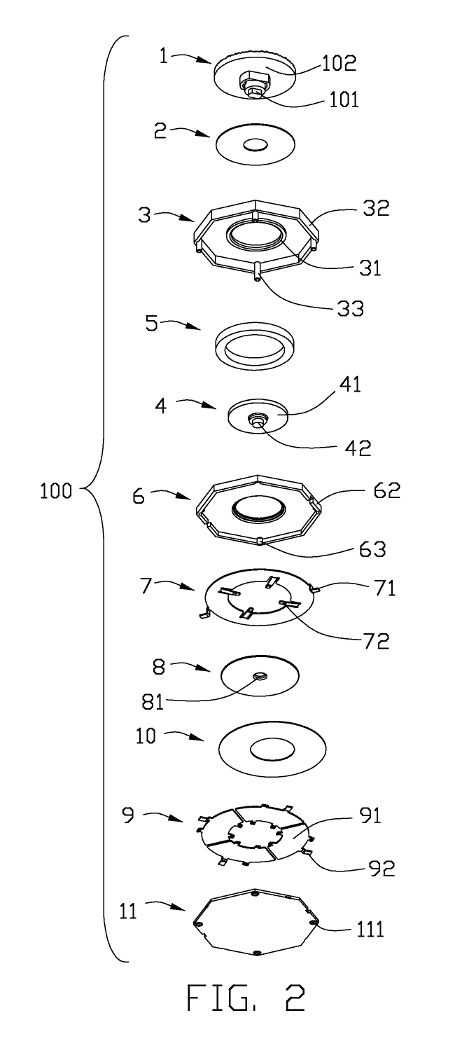

Referring to FIGS. 2-4, the upper housing 3 and the lower housing 6 are both ring configured. Each of the upper housing 3 and the lower housing 6 has a circular inner edge 31, 61 and a circular outer edge 32, 62. The circular inner edges 31, 61 of the upper housing 3 and the lower housing 6 respectively protrudes downwardly and upwardly from main surfaces of the upper housing 3 and the lower housing 6 but not connect with each other and therefore, define a channel 361 therebetween. The circular outer edge 32 of the upper housing 3 extends downwardly from the main surface of the upper housing 3 and connects with the main surface of the lower housing 6 and therefore, a first receiving space 362 is defined between the upper housing 3 and the lower housing 6. The first receiving space 362 is communicated with outside via the channel 361. The circular outer edge 62 of the lower housing 6 extends downwardly from the main surface of the lower housing 6 and connects with the bottom cover 11 and therefore, a second receiving space 611 is defined between the lower housing 6 and the bottom cover 11. The upper housing 3 comprises a plurality of poles 33 extending from the circular outer edge 32. The lower housing 6 defines a plurality of holes 63 and the bottom cover 11 defines a plurality of cutouts 111 corresponding to the holes 63. The poles 33 extend through the holes 63 and finally are retained in the cutouts 111. Therefore, the upper housing 3, the lower housing 6, and the bottom cover 11 are secured with each other.

Referring to FIGS. 2-4, the elastic ring 5 is received in the first receiving space 362. The elastic ring 5 has an inner diameter a little larger than that of the circular inner edges 31, 61 of the upper housing 3 and the lower housing 6, and therefore, the elastic ring 5 is received in the first receiving space 362 and attached to the circular inner edges 31, 61 of the upper housing 3 and the lower housing 6. The actuator 4 has a bracket 41 and an actuating portion 42 extending downwardly from a central portion of the bracket 41. The bracket 41 is received in the channel 361 and connects with the elastic ring 5. The bracket 41 defines an aperture 43 at the center thereof. The operating button 1 comprises an operating portion 102 positioned upon the upper housing 3 for facilitating a user's operation and a protrusion 101 extending downwardly from the operating portion 102. The dust-preventing plate 2 is sandwiched between the operating portion 102 of the operating button 1 and the upper housing 3 for preventing dust or others from entering interior of the multi direction switch 100. The protrusion 101 enters into the aperture 43 of the actuator 4 by extending through the dust-preventing plate 2, the upper housing 3 in turn and then such that the operating button 1 is assembled on the actuator 4 and the operating button 1 is capable of driving the actuator 4 to move along multi directions. The actuator 4 moves along multi directions from an original position and compresses the elastic ring 5 at different positions and the elastic ring 5 reacts on the actuator 4 for returning back to the original position.

Referring to FIGS. 2-4, the moveable electrode plate 8 is overlapped on the actuating portion 42 of the actuator 4 and therefore, the actuator 4 is capable of actuating the moveable electrode plate 8. The terminal plate 7 is positioned above the moveable electrode plate 8 and below the lower housing 6. The terminal plate 7 comprises a plurality of pins 71 soldering on the printed circuit board and a plurality of flexible portions 72 contacting with the moveable electrode plate 8. The moveable electrode plate 8 is electrically connected with the printed circuit board via the terminal plate 7. The fixed electrode plate 9 is positioned above the bottom cover 11 and below the moveable electrode plate 8. The fixed electrode plate 9 has a plurality of sectors 91 each being insulated from the other. Each sector 91 has a pad 92 soldering on the printed circuit board. The moveable electrode plate 8 and the fixed electrode plate 9 are opposing with each other. The insulative layer 10 is sandwiched between the moveable electrode plate 8 and the fixed electrode plate 9 along a vertical direction. The moveable electrode plate 8 and the fixed electrode plate 9 have capacity therebetween when they are electrified. The bottom cover 11 defines a plurality of fan-shaped sections 110 receiving the sectors 91 of the fixed electrode plate 9. All of the terminal plate 7, the moveable electrode plate 8, the insulative layer 10, and the fixed electrode plate 9 are received in the second receiving space 611 and positioned along an upper-and-lower direction namely the vertical direction.

Because the moveable electrode plate 8 is overlapped on the actuating portion 42 of the actuator 4 and therefore, the moveable electrode plate 8 moves along a horizontal direction perpendicular to the upper-and-lower direction along with the actuator 4 when a user operates on the operating button 1. The opposing area between the moveable electrode plate 8 and the fixed electrode plate 9 is changed. Accordingly, the capacity between the moveable electrode plate 8 and the fixed electrode plate 9 is altered and different signals are output to the printed circuit board. Therefore, the operating button 1 moves to multi directions and denotes multi positions of the electronic appliance. The moveable electrode plate 8 is easily moved by the actuator 4 because the moveable electrode plate 8 is positioned at a level upper than the insulative layer 10 and of course is nearer to the actuator 4 than the insulative layer 10. The moveable electrode plate 8 is connected with the actuator 4 without interference. The multi direction switch 100 of the present invention facilitates alteration of opposing area of two electrode plates 8, 9. Besides, with the flexible portions 72 of the terminal plate 7 sliding on the moveable electrode plate 8, relative movement thereof can be detected so as to determine the moving direction of the operating button 1.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A multi direction switch comprising:
an upper housing and a lower housing together defining a channel and a first receiving space communicating with the channel;
a bottom cover attached to the lower housing for defining a second receiving space therebetween;
an elastic ring received in the first receiving space;
an actuator having a bracket extending through the channel to contact with the elastic ring and an actuating portion extending from the bracket towards the bottom cover;
an operating button having an operating portion positioned above the upper housing and a protrusion extending downwardly from the operating portion, the protrusion retained by the bracket; and
a terminal plate, a moveable electrode plate, an insulative layer, and a fixed electrode plate positioned in order from top to bottom and received in the second receiving space; wherein
the moveable electrode plate is mounted to the actuating portion of the actuator.

2. The multi direction switch as claimed in claim 1, wherein the moveable electrode plate is moveable along a horizontal direction.

3. The multi direction switch as claimed in claim 2, wherein the terminal plate is positioned between the moveable electrode plate and a bottom face of the lower housing.

4. The multi direction switch as claimed in claim 3, wherein the terminal plate comprises a plurality of pins for soldering on a printed circuit board and a plurality of flexible portions contacting with the moveable electrode plate.

5. The multi direction switch as claimed in claim 3, wherein the moveable electrode plate is positioned on the bottom cover and overlays the insulative layer and the underlying fixed electrode plate.

6. The multi direction switch as claimed in claim 5, wherein the fixed electrode plate has a plurality of sectors each insulated from the other and each sector has a pad for soldering on a printed circuit board.

7. The multi direction switch as claimed in claim 5, wherein the insulative layer is sandwiched between the moveable electrode plate and the fixed electrode plate.

8. The multi direction switch as claimed in claim 2, wherein the bracket defines an aperture at the center thereof and the protrusion enters into the aperture.

9. The multi direction switch as claimed in claim 2, wherein the upper housing comprises a plurality of poles, the lower housing defines a plurality of holes, the bottom cover defines a plurality of cutouts, and the poles extend through the holes and are retained in the cutouts.

10. The multi direction switch as claimed in claim 2, further comprising a dust-preventing plate positioned between the operating portion of the operating button and the upper housing.

11. A multi-direction switch for mounting to a printed circuit board, comprising:
a case defining receiving cavity;
a set of upper fixed contacts located at a first level with first tails extending downwardly for mounting to the printed circuit board;
a set of lower fixed contacts located at a second level below the first level with second tails extending downwardly for mounting to the printed circuit board;
a moveable contact and an insulative plate sandwiched between the upper fixed contacts and the lower fixed contacts under condition that the moveable contact and the insulative plate abut against each other, the moveable contact contacts one set of the lower and upper fixed contacts while the insulative plate contacts the other; wherein
movement of the movable contact in multi directions results in alteration capacity between the upper and lower fixed contacts for different outputting.

12. The multi-direction switch as claimed in claim 11, wherein the movable contacts is actuated to move by an actuator which is restrained in an elastic ring.

13. The multi-direction switch as claimed in claim 11, wherein the movement of the moveable contact performs horizontally.

14. The multi-direction switch as claimed in claim 11, wherein one of the moveable contact, and the set of the fixed contacts which contacts the moveable contact, is equipped with a plurality of resilient fingers abutting against the other.

15. The multi-direction switch as claimed in claim 14, wherein the set of upper fixed contacts is equipped with the plurality of resilient fingers.

16. The multi-direction switch as claimed in claim 11, wherein the set of fixed contacts which contacts the movable contact, is integral as one piece.

17. The multi-direction switch as claimed in claim 16, wherein said set of fixed contacts is the set of upper fixed contacts.

18. A multi-direction switch for mounting to a printed circuit board, comprising:
a set of first fixed contacts located at a first level;
a set of second fixed contacts located at a second level different from the first level;
a movable contact located between the set of first fixed contacts and the set of second fixed contacts under condition that the movable contact constantly contacts the set of first fixed contacts while being spaced from the set of second fixed contacts; and
an actuator circumferentially restrained by an elastic ring and selectively actuating the movable contact to move in different directions.

19. The multi-direction switch as claimed in claim 18, wherein the first fixed contacts include a plurality of resilient fingers to selectively contact the moveable contact.

20. The multi-direction switch as claimed in claim 19, wherein the first fixed contacts are integrally formed as one piece sharing at least one soldering tails for mounting to the printed circuit board, while the second fixed contacts are discrete from one another with respective soldering tails for mounting to the printed circuit board.
